(19) United States
(12) Patent Application Publication
(10) Pub. No.: US 2020/0055122 A1
(43) Pub. Date: Feb. 20, 2020

(54) METHOD FOR ADDITIVE MANUFACTURING WITH SELECTIVE REMOVAL OF BASE MATERIAL

(71) Applicant: Siemens Aktiengesellschaft, Munich (DE)

(72) Inventor: Ole Geisen, Berlin (DE)

(73) Assignee: Siemens Aktiengesellschaft, Munich (DE)

(21) Appl. No.: 16/344,437

(22) PCT Filed: Oct. 18, 2017
(86) PCT No.: PCT/EP2017/076539

§ 371 Date: Apr. 24, 2019

(30) Foreign Application Priority Data
Nov. 16, 2016 (DE) 10 2016 222 564.2

(51) Int. Cl. B22F 7/04; B22F 3/105; B33Y 10/00; B33Y 40/00

(52) U.S. Cl. CPC B22F 7/04; B22F 3/1055; B22F 2003/247; B33Y 40/00; B33Y 10/00

(57) ABSTRACT

A method for the additive manufacturing of a component, includes the selective removal, in particular suctioning, of a base material for the component during the additive buildup, wherein the base material is removed from a predetermined region of a production surface during a movement of a coating device for the additive manufacturing.

### CROSS REFERENCE TO RELATED APPLICATIONS

This application is the US National Stage of International Application No. PCT/EP2017/076539 filed Oct. 18, 2017, and claims the benefit thereof. The International Application claims the benefit of German Application No. DE 10 2016 222 564.2 filed Nov. 16, 2016. All of the applications are incorporated by reference herein in their entirety.

### FIELD OF INVENTION

The present invention relates to a method for the additive or layered manufacturing of a component and also to a device for the additive manufacturing of the component and to a corresponding plant.

The component can furthermore consist of a high temperature-resistant alloy or comprise this.

The component may be provided for use in a turbomachine, advantageously in the hot gas path of a gas turbine. The component advantageously consists of a nickel-based alloy or superalloy, especially a nickel-based or cobalt-based superalloy. The alloy can be precipitation hardened or able to be precipitation hardened.

### BACKGROUND OF INVENTION

As powder bed processes, generative or additive manufacturing processes comprise for example selective laser melting (SLM) or selective laser sintering (SLS), or electron beam melting (EBM). Laser metal deposition (LMD) is also associated with the additive processes.

Additive or generative manufacturing processes have proved to be particularly advantageous for complex or complicated or delicately designed components, for example labyrinthine structures, cooling structures and/or lightweight structures. Additive production by means of a particularly short chain of process steps is especially advantageous since a manufacturing or production step of a component can be carried out directly on the basis of a corresponding CAD dataset.

Furthermore, additive production is particularly advantageous for the development or manufacturing of prototypes which for example cannot be manufactured, or not manufactured efficiently, by means of conventional subtractive or cutting processes or casting technology for cost reasons.

A problem which frequently occurs in powder bed-based additive manufacturing is the difficulty in reliably removing a powdered base material again from individual regions, cavities or hollows which the component has on account of its predetermined geometry.

Furthermore, it may be practical, during quality control or monitoring of the coating result or build-up result during the additive manufacturing, to free an individual region, especially a region already coated with powder, on a production surface in the installation space, completely or partially of powder or base material, especially during the additive build-up. It is especially desirable to improve the surface quality of side surfaces of the component. If these side surfaces are not in direct contact with powder, the surface can be machined, for example using a laser or another tool, in an intermediate step and its quality improved.

Processes already described in the prior art, with which especially after the additive manufacturing, for example after a protective gas atmosphere for the actual component had been removed again, allowed the installation space, in which the component is located, to be freed of surplus powder, especially by means of corresponding suction devices.

A method for additive manufacturing using a powder suction device is known for example from DE 10 2013 206 205 A1.

With powder already deposited on a production surface during the additive buildup of individual layers, especially between or during the solidification of individual layers, the described known methods, however, do not allow regions of the production surface to be freed of powder again. This, however, can be particularly advantageous or even indispensable when the component has a complex geometry, and when cavities with difficult access have to be freed of powder for the functionality of the component. Powdered base material can otherwise, i.e. after final buildup of the component, possibly not be removed at all, especially if the cavities are completely closed. A subsequent heat treatment would then at least sinter this powder, as a result of which the functionality of the corresponding cavity would be significantly limited or destroyed.

### SUMMARY OF INVENTION

It is therefore an object of the present invention to specify means which allow the selective removal, especially sucking out, of base material during the additive manufacturing, i.e. during or between the additive buildup of individual layers for a component.

This object is achieved by means of the subject matter of the independent patent claims. Advantageous embodiments are the subject matter of the dependent patent claims.

One aspect of the present invention relates to a method for the additive, especially layered, manufacturing of a component, comprising the selective removal, especially sucking out, of a base material for the component during the additive buildup of the component.

In one embodiment, the base material can be selectively removed between the additive buildup of individual component layers or during the additive buildup of an individual component layer or of a corresponding coating.

The referenced additive build up advantageously also comprises the coating of a production surface with a base material and the subsequent solidification of the resulting layer by irradiation by, or exposure to, an energy source, for example a laser beam or electron beam.

In the case of the described method, the base material is removed from a predetermined region of a production surface during a movement, advantageously a horizontal movement, of a coating device for the additive manufacturing. In other words, the base material can be removed according to the described method advantageously on or in the production surface or in any other region, already coated with base material, in an installation space.

The referenced region of the production surface is advantageously a (lateral) sub-region thereof, i.e. for example seen in plan view of the production surface.

The referenced production surface is expediently a surface in the installation space which is formed by a base material layer, and is defined by a powder bed accordingly. The production surface can also relate to a region in the powder bed of the base material, also to a region which for example is located laterally next to already solidified component layers. Accordingly, powder beneath the production surface—for example between exposure steps or solidification steps of individual layers—can also be removed.

The described method is particularly advantageous if, for example as indicated above, the edge or a vertical side surface of the component is to be aftermachined—for example by material removal or renewed re-melting using the laser. Such aftermachining is enabled in the first place by the described method.

The rough surface is selectively created with layers melted by a laser in the case of the SLM process by powder particles being drawn into the molten bath.

The production surface can alternatively constitute a surface of a component substrate or a part of a component already additively built up which is covered with the base material.

Especially due to the fact that the selective removal of the base material from the predetermined region is carried out during the additive buildup of the actual component and during a movement of a coating device for the additive manufacturing, the additive build up process can be particularly advantageously influenced. In particular, the base material can be removed again in layers from previously already built up spaces of the component. Furthermore—for example during quality assurance or quality monitoring, a coating result can be corrected and/or even weld spatter together with any other surplus base material can be sucked out of the installation space in layers.

In one embodiment, the method is a powder bed-based additive manufacturing process.

In one embodiment, the base material is a source powder for the component.

In one embodiment, the selective removal is carried out by means of suction.

In one embodiment, the selective removal is carried out during a coating process of the method. This embodiment advantageously enables a particularly practical and above all time-efficient sucking out of powder since this is carried out in one step with the powder application. Furthermore, this embodiment relates to a particularly simple way for example of implementing the powder removal using hardware technology since a corresponding suction head or a nozzle (see below) can be attached to a coating device.

In one embodiment, the selective removal is carried out during a backward movement, for example in a rearward direction, of the coating device for the additive manufacturing. This embodiment also enables the utilization of the aforesaid advantages.

In one embodiment, the selective removal is carried out after an exposure process of the method. This embodiment can be particularly expedient for the above-described mechanical aftermachining of side surfaces of the component.

In one embodiment of the method, a build platform, on which the component is expediently additively built up, is lowered during the removal or sucking out. This advantageously allows the coating device, for example a blade, a slide or a brush, to avoid colliding with a previously built up component layer or a part of the component and causing damage.

In one embodiment, sidewalls of the component or of an already solidified part thereof, which adjoin the predetermined region and have been freed of powdered base material, are mechanically aftermachined after the selective removal. As described above, this enables the improvement of the surface quality of the component and therefore possibly also the component function.

In one embodiment, the method is a powder bed-based process, for example a process for selective laser melting, and the base material is a powdered base material, wherein the selective removal is carried out by means of sucking out the powder.

In one embodiment, the method is a stereolithography process and the base material is a liquid base material. According to this embodiment, the base material can also be sucked out and/or pumped out.

In one embodiment, the method comprises the introduction of at least one pre-manufactured component element, after the selective removal, into an additive build up or into a region above the production surface in such a way that the component element delimits a cavity, defined by sucked out powder and a solidified structure of the component, directly in or along a build-up direction. In other words, the component element, which for example is an (additively) pre-manufactured part of the component, advantageously consisting of the same material as the prospective component, can delimit a cavity for the component as a bridge. In this way, the manufacturing of costly support structures, which are necessary in powder bed-based processes in the case of larger overhangs or undercuts, can advantageously be dispensed with. In the event that the described cavity is completely closed according to the predetermined geometry of the component, this embodiment in the first place enables additive production since otherwise there is no way of removing existing powder from the cavity again by means of the described method without subsequent cutting machining.

Such cutting machining, however, before an obligatory heat treatment after the additive build up (solution annealing), can be critical on account of the stress conditions in the component which arise during the buildup and can frequently lead to crack development or even to destruction and scrapping of the component.

After a corresponding heat treatment, the powder in the space would also already be sintered, which also makes subsequent removal of the sintered structure from the cavity decidedly difficult or impossible.

In one embodiment, software or a data processing program automatically or semi-automatically calculates the quantity of base material required for a subsequent coating process based on a volume of the previously removed base material (by suction).

In one embodiment, the method comprises the lateral coating of the production surface with the base material by means of a coating device, wherein—depending on the volume to be coated of the region of the production surface brushed over by the coating device—the coating speed is adjusted for an optimum or advantageous coating result. In this way, the coating result and therefore possibly the later microstructure or surface quality for the actual component can especially be improved. Furthermore, the flow behavior of the powdered base material can be taken into account in this way and/or a flawed coating can be prevented.

In one embodiment, the adjustment of the coating speed is also carried out by means of the described software.

In one embodiment, the coating speed for large (predetermined) layer thicknesses or for large volumes or cavities which are to be covered with base material is selected to be lower than for proportionally smaller coating thicknesses or smaller volumes which are to be covered with base material.

A further aspect of the present invention relates to a device for the additive manufacturing of the component, which is designed to selectively remove the base material, according to the described method, from the predetermined region by means of suction.

In one embodiment, the device has a suction head or a nozzle which is connected to the coating device for the additive manufacturing and can move relative to the production surface.

In one embodiment, the suction head can move both laterally along the production surface and perpendicularly to the production surface so that powder beneath the production surface can also be removed. Ideally, the device is designed in such a way that the suction head reaches each (lateral) point or region on the build plate or on the production surface, i.e. in the XY-direction, for example. In addition, the suction head can advantageously be lowered into a powder region beneath the production surface, i.e. in the Z-direction, in order to remove powder there.

In one embodiment, suction power of the device is measured sufficiently to move component elements up to a predetermined or critical thickness or up to a critical weight of the respective component element over the production surface or in the installation space into a build up by means of a negative pressure during the additive manufacturing. A component element can advantageously be moved from one region, for example seen in plan view of a production surface, in which no base material is retained, into a region above the production surface (over a cavity). In this sense, the device can function as a positioning means for component elements.

The referenced thickness can for example be a layer thickness of a layer of the base material which is to be deposited or a multiple thereof.

In one embodiment, the device is designed so as to remove (previously) removed base material via a protective gas suction device from a manufacturing or installation space for the additive manufacturing.

In one embodiment, the device has a collecting bin in which sucked out base material, for example up to a possible emptying at the end of the manufacturing of the component, can be retained.

A further aspect of the present invention relates to a plant for the additive manufacturing, comprising the coating device and the device as described above.

Embodiments, features and/or advantages, which in the present case relate to the method, can also relate to the device or to the plant, or vice versa.

### BRIEF DESCRIPTION OF THE DRAWINGS

Further details of the invention are described below with reference to the figures.

FIG. 1 shows a schematic sectional or side view of a plant, comprising a device according to the invention.

FIG. 2, corresponding to the view of FIG. 1, shows an alternative view of the device according to the invention.

FIGS. 3 to 6 indicate in each case, in a view similar to FIGS. 1 and 2, method steps according to the invention.

FIGS. 7 and 8 indicate in each case, in a view similar to FIGS. 1 and 2, embodiments of the method according to the invention.

FIG. 9 shows a schematic flow diagram of the method according to the invention.

### DETAILED DESCRIPTION OF INVENTION

In the exemplary embodiments and figures, the same elements or elements functioning in the same way can be provided in each case with the same designations. The depicted elements and their proportional relationships to each other are not basically to be seen as being to scale, rather individual elements can be shown as being excessively thick or with large dimensions for better presentability and/or for better understanding.

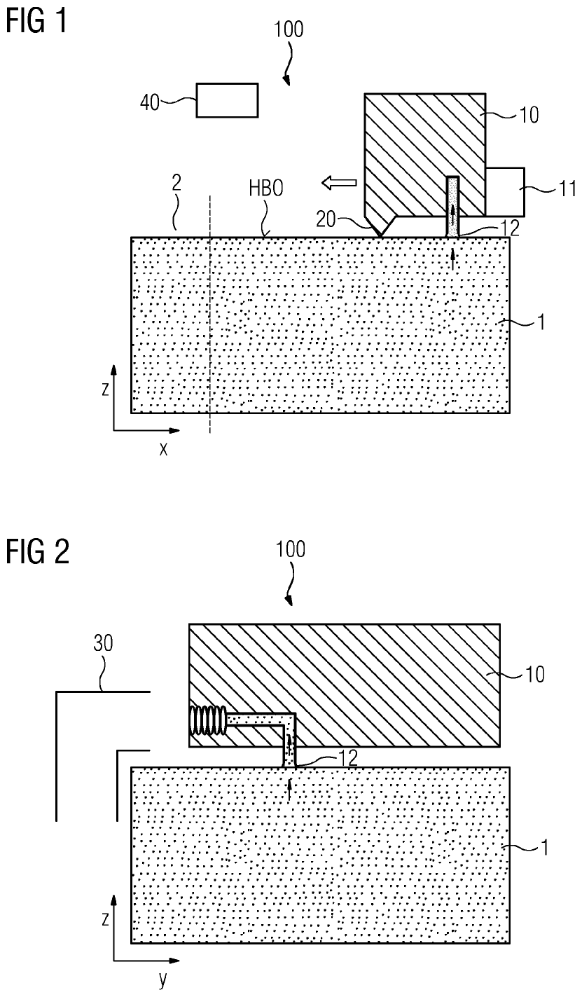

FIG. 1 shows a plant 100 for the additive manufacturing of a component 3. The plant 100 comprises a device 10 for the additive manufacturing of the component 3.

In the case of the additive manufacturing process for the component 3, described in the present case with reference to the plant 100 and to the device 10, it is advantageously a powder bed-based manufacturing process, advantageously a selective laser melting process, or alternatively to this, an electron beam melting process or selective laser sintering process.

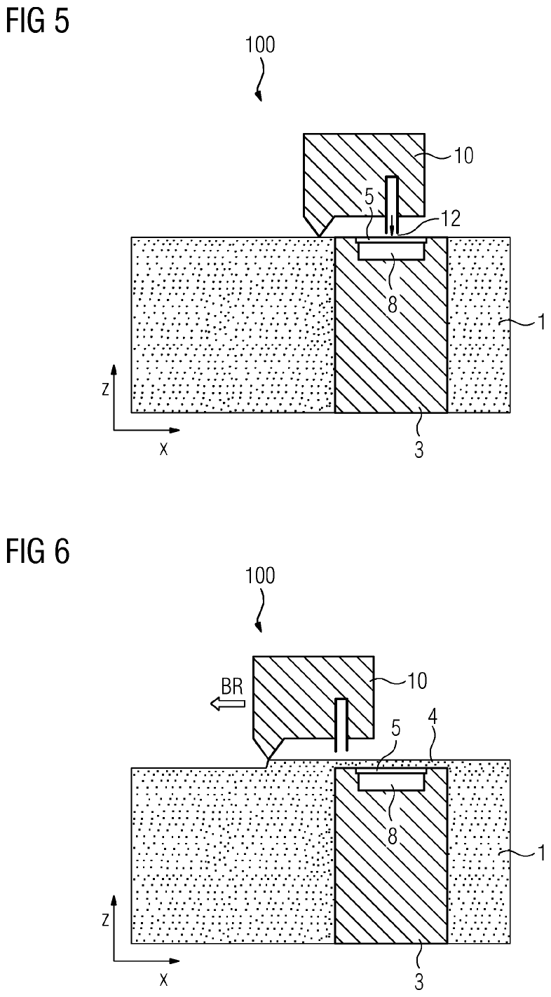

Shown in the bottom region of FIG. 1 is a powder bed with a powdered base material 1 for the component 3 (compare FIG. 3). The base material 1 forms a powder bed with a production surface HOB. Shown above the production surface HOB is the device 10. The device 10 is a device for the selective removal, especially sucking out, of powder from regions of the production surface HOB in order to simplify or to improve an additive manufacturing process for the component 3.

The component 3 is advantageously a high temperature-resistant component, advantageously for use in the hot gas path of a gas turbine. Consequently, the component 3 is advantageously produced from a nickel-based alloy or superalloy. Consequently, the base material is advantageously a powder of a corresponding alloy.

The device 10 comprises a suction head 12. The suction head 12 advantageously has a comparatively small diameter for sucking out the base material or powder in order to provide a corresponding suction power (for the powder removal) for an expedient spatial dissipation. The suction head 12 is also advantageously movable relative to the production surface HOB, i.e. in the X, Y and Z-directions (compare the coordinate systems at bottom left in the powder bed). The Z-direction advantageously describes a buildup direction for the component (compare FIG. 3).

The device 10 furthermore comprises a collecting bin 11 in which the removed or sucked out powder can be collected and held for example during the movement of the device 10. The base material or powder 1, differing from that identified in the figure, can be directed by means of a corresponding pipe or hose into the collecting bin 11 and be separated out therein for example by means of a cyclone.

The device 10 advantageously also has a coating tool or a coating device 20. The device 10 can especially be connected to the coating device 20 or be provided in one piece with this. The coating device 20 can for example comprise or constitute a slide, a doctor knife, a blade and/or a brush.

Alternatively or additionally, the device 10 could be connected to the coating device 20 in such a way that the device 10 is still movable, for example in the X- and/or Y-direction relative to the coating device. Consequently, the device 10—similar to a carriage—could be able to run over a rail for example in the X- and/or Y-direction.

FIG. 1 furthermore shows an irradiating device, advantageously a device for exposing the powder bed to a laser beam or electron beam according to a geometry which is predetermined for the component 3. The geometry advantageously already exists in the form of CAM/CAD data or other construction data before the manufacturing process. By the same token, the component is already divided into the individual component layers (“slicing”) in the construction data beforehand.

By means of the vertical dashed line in FIG. 1, it is indicated purely schematically that the powder bed can comprise a spillover at the edge into which surplus powder which is moved by the coating device 20 can be emptied.

FIG. 1 advantageously shows a sectional view sectioned along the XZ-plane (compare coordinate system at bottom left).

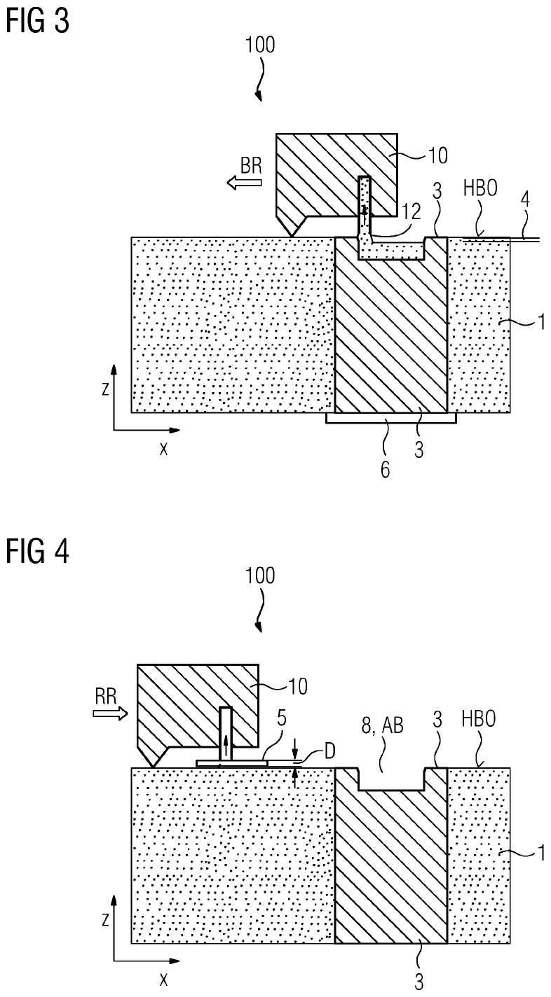

FIG. 2 shows an alternative view of the device 10. In contrast to FIG. 1, the device from FIG. 2 shows a connection, connected to a protective gas suction device 30, via which the powder 1 can be removed for example from a manufacturing or installation space (not further identified). This advantageously takes place during a movement of the coating device 20. The referenced connection (not explicitly identified in the figure) can have an angle piece, especially of any practical shape, which is advantageous for producing a fluidic communication between the suction head 12 and the protective gas suction device 30.

In the embodiment of the device 10 according to FIG. 2, the collecting bin 11 shown in FIG. 1 can be dispensed with.

FIG. 2 shows a sectional or side view sectioned along the YZ-plane (compare coordinate system at bottom left).

FIG. 3 shows a situation of the plant 100 in which a component 3 has already been partially additively built up, that is to say built up in layers by alternative coating of the production surface HOB and by irradiating the corresponding powder layer, e.g. by means of a laser beam. The component 3, as is customary in additive production, has been built up on a lowerable build platform 6.

It is also shown that during a movement of the device 10 along a coating direction BR (compare arrow directed to the left) base material is removed from the production surface HOB above the component 3 by means of suction. This can also be carried out in a number of steps or movements of the device 10.

FIG. 4 shows a method step of the method according to the invention, in which subsequent to the situation shown in FIG. 3, but advantageously after a complete cavity 8 or sucked out region AB has been freed of base material 1 (compare FIG. 4), a component element 5 is advantageously moved from a location behind the described spillover into a region above the component 3 and advantageously above the referenced cavity 8. The component element is in particular moved along a rearward direction RR which is opposite to the coating direction BR.

During the sucking out, for example during the rearward movement RR of the coating device 20, the build platform 6 can also be lowered. In this way, the coating device 20, e.g. its blade, does not touch the last produced component layer.

Since, moreover, depending on the suction power of the device 10, powder can only be sucked out from a specified depth of the powder bed, the suction head 12 or a corresponding nozzle thereof can be movable along the Z-direction and can also suck out powder 1 below the production surface HOB accordingly.

The component element 5 can consist of the same or a similar material as the rest of the component 3. The component element 5 can for example be pre-manufactured by means of the same method.

Shown in FIG. 5 is a situation in which the component element 5 has already been moved by the device 10 onto the component 3 by means of a negative pressure applied by the suction head 12 in such a way that the cavity 8 is completely covered.

For this purpose, a thickness of the component element 5 should not be selected to be excessively thick in order to also keep the weight of the component element within reasonable limits and to be able to reliably suck it on and moved it by means of the suction head 12.

The thickness D of the component element 5 can for example correspond to a multiple of a component layer thickness or to a corresponding thickness of a layer of the base material. Normal base material layer thicknesses lie within the range of between 20 and 50 μm. The thickness D can for example be a few millimeters.

Reference should be made to the fact that the sucking on of the component element 5 and the removal of the base material 1 from the production surface HOB offers an associated advantage (synergy) for the described method since only in this way can closed cavities in additively produced components be freed of powder and therefore be expediently manufactured without excessively complicated plant engineering.

Correspondingly, the cavity 8, which in addition to the component element 5 is also defined by the hitherto built up structure of the component 3, can be completely closed (compare FIG. 6).

During the further additive manufacturing, a production surface, formed by the component element 5, is now advantageously coated with new base material (a coating with new base material is not explicitly identified in FIGS. 3 to 6), as a result of which more stability can be imparted to the structure of the component with the increase in built up layers, and therefore a bridge also extends over the cavity 8 without the risk of breaking.

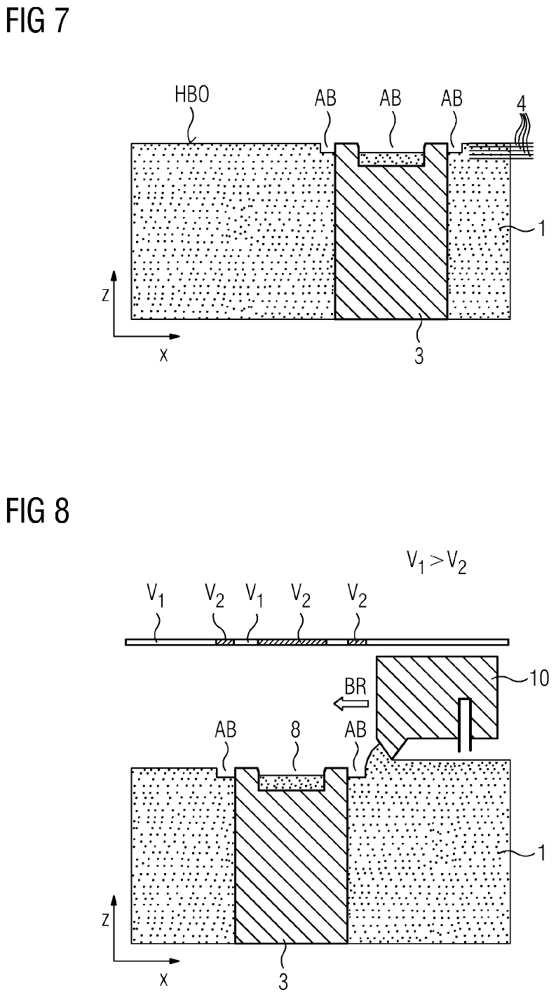

FIG. 7 shows a situation in which a production surface, especially regions in places of the component 3 solidified last, has been freed of base material 1 by the device (not explicitly identified in FIG. 7), as described above. These regions are identified by AB (sucked out region). It can in particular be expedient to free edge regions of the component 3 of powder during the additive manufacturing in order to machine the edge regions mechanically or using the laser without the adjacent powder influencing the process.

FIG. 8 schematically indicates that within the scope of the present invention, for example depending on flow behavior of the powder in specified regions of the production surface, the coating speed, in contrast to other V1-regions, can be altered in order to ensure a cleaner or more reliable filling up, deposition or coating.

In other words, the described method can comprise the lateral coating of the production surface HOB with base material 1 by means of the coating device 20, wherein—depending on the volume to be covered of the lateral region of the production surface HOB brushed over by the coating device—the coating speed (cf. V1, V2) is adjusted for an optimum coating result.

For example, for large coating thicknesses or for large volumes to be covered with base material 1 the coating speed V2 can be selected to be lower than for proportionally smaller layer thicknesses or smaller volumes to be covered with base material 1 in order to achieve a better coating result.

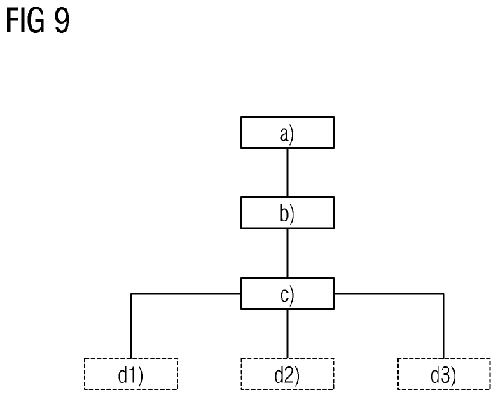

The coating speed can also be adjusted or reduced automatically or semi-automatically via software (compare method steps B in FIG. 9). In particular, starting from a specified sucked out volume multiple coatings can be, or should be, applied as standard. A so-called “boost factor” in the software can for example automatically adjust the quantity of powder which is made available in a coating step.

After deposition of a new layer in a region previously freed of powder, a check can advantageously be carried out as to whether a uniform powder bed exists again. This can be carried out visually or by other suitable means. In the event of a negative result, the coating process can be repeated (before scanning or exposure).

FIG. 9 shows schematically and possibly incompletely method steps according to the invention based on a flow diagram.

The flow diagram comprises a method step a) which relates to a coating step, for example of the above-described production surface HOB. This step can be a conventional technique or a technique which is common in the prior art for coating a component surface.

The method step b) describes an exposure to, irradiation by, or subjection to, an energy beam, for example a laser beam, in order to correspondingly additively build up the component according to its predetermined geometry (see above).

In a subsequent method step (not explicitly identified in FIG. 9), a data processing device of the plant 100 and/or of the device 10, for example via a corresponding program or software, can automatically calculate the quantity of base material 1 required for a subsequent coating process, based on the volume of the previously removed base material 1. The sucked out volume in this case increases the quantity of powder which has to be deposited in the following step, unless the volume has been closed off in an intermediate step by the insertion of a component element, as described above. This aspect can be automatically adjusted by the described software for example by a “travel distance”, along which a piston of a powder feed device is moved upward for example along the Z-direction, being increased each time via a corresponding parameter in the software. In the case of other deposition mechanisms the deposited quantity of powder can also be correspondingly adjusted.

The method step c) advantageously relates to the selective removal of the base material for predetermined regions of the production surface, especially for freeing regions of the component which are not intended to hold powder, as described above, by suction.

As possible subsequent method steps, the steps d1), d2) and d3) are shown cumulatively or alternatively in FIG. 9.

Step d1) indicates a further exposure step (laser scanning) for solidifying the base material (cf. step b) above). After the selective removal of the powder, further powder-freed or deeper lying regions can therefore be exposed and/or remelted within the scope of the present invention.

Step d2) indicates a possible mechanical afterworking of side surfaces of the component which are freed of powder, as described above, in order to improve corresponding surface properties.

Step d3) relates to the introduction of a component element, as described above, especially for covering a cavity, so that in this region the construction of costly support structures can be advantageously dispensed with.

The method steps shown in the flow diagram of FIG. 9 can advantageously be iteratively implemented within the scope of an additive manufacturing process.

By the description based on the exemplary embodiments, the invention is not limited to these but covers each new feature and each combination of features. This especially contains each combination of features in the patent claims, even if this feature or this combination itself is not explicitly disclosed in the patent claims or exemplary embodiments.

1.-14. (canceled)

15. A method for additive manufacturing of a component, comprising:
selectively removing a base material for the component during additive build up, wherein the base material is removed from a predetermined region of a production surface during a movement of a coating device for the additive manufacturing, and
introducing at least one pre-manufactured component element, after the selectively removing, into an additive buildup in such a way that the component element delimits a cavity, defined by removed base material, directly in a buildup direction.

16. The method as claimed in claim 15,
wherein the selectively removing is carried out during a coating process of the method.

17. The method as claimed in claim 15,
wherein the selectively removing is carried out during a rearward movement of a coating device for the additive manufacturing and/or after an exposure process.

18. The method as claimed in claim 15,
wherein sidewalls of the component, which adjoin the predetermined region, are mechanically afterworked after the selectively removing.

19. The method as claimed in claim 18,
wherein the component element for the additive buildup of a subsequent component layer forms at least partially a production surface which, after introduction of the component element, is coated with a new base material layer.

20. The method as claimed in claim 15,
wherein software automatically calculates a quantity of the base material required for a subsequent coating process, based on a volume of the removed base material.

21. The method as claimed in claim 15, further comprising:
laterally coating of the production surface with the base material by a coating device, wherein, depending on a volume to be covered of the region of the production surface brushed over by the coating device, the coating speed is adjusted for an optimum coating result.

22. The method as claimed in claim 21,
wherein for large layer thicknesses or for large volumes to be covered with base material the coating speed is selected to be lower than for proportionally smaller layer thicknesses or smaller volumes to be covered with base material.

23. A device for the additive manufacturing of a component, wherein the device is designed for selectively removing a base material from the predetermined region by suction during the additive manufacturing according to the method as claimed in claim 15, comprising:
a suction head which is connected to a coating device for the additive manufacturing and is moveable relative to the production surface.

24. The device as claimed in claim 23,
wherein the suction head is moveable both laterally along the production surface and perpendicularly to the production surface so that powder beneath the production surface is also removeable.

25. The device as claimed in claim 23,
wherein a suction power of the device is sufficient to move component elements up to a predetermined thickness over the production surface by a negative pressure during the additive manufacturing.

26. The device as claimed in claim 23, further comprising:
a protective gas suction device which is designed for removing the removed base material via from a production space for the additive manufacturing.

27. A plant for additive manufacturing, comprising:
the coating device, and
the device for the additive manufacturing of a component as claimed in claim 23.

28. The method as claimed in claim 15,
wherein the selectively removing of the base material comprises suction.
